(19) United States
(12) Patent Application Publication
(10) Pub. No.: US 2025/0099216 A1
(43) Pub. Date: Mar. 27, 2025

(54) COUPLING SECTION FOR PERSONAL-CARE IMPLEMENT AND PROCESS OF MAKING SAME, INCLUDING TOLERANCE COMPENSATION

(71) Applicant: Braun GmbH, Kronberg (DE)

(72) Inventors: Carina Sabrina SCHLEICHER, Gross-Gerau (DE); Ariana Isabel Kenez Salavessa RUPP, Frankfurt Am Main (DE); Norbert SCHAEFER, Frankfurt Am Main (DE); Florian BAIER, Frankfurt (DE)

(21) Appl. No.: 18/884,291

(22) Filed: Sep. 13, 2024

Related U.S. Application Data
(60) Provisional application No. 63/584,239, filed on Sep. 21, 2023.

(51) Int. Cl. A61C 17/22

(52) U.S. Cl. CPC A61C 17/225

(57) ABSTRACT

A coupling section for coupling a handle of a personal-care implement and a replaceable attachment tool includes a cap, a bushing mounted inside the cap, a drive shaft having a free end terminating in the bushing, a first magnetic coupling element mounted in the cap, and an elastic magnet seal disposed between the first magnetic coupling element and the bushing. The magnet seal is structured and configured to flex in at least a direction along the longitudinal axis of the bushing, thereby providing at least longitudinal tolerance compensation for the drive shaft relative to the first magnetic coupling element.

### FIELD OF THE INVENTION

The present disclosure is concerned with the mass manufacturing of multi-component personal-care implements, such as, e.g., personal-care devices, including electric toothbrushes.

### BACKGROUND OF THE INVENTION

Mass production of multi-component personal-care implements, such as, e.g., toothbrush handles and other similar items, are typically made by a multi-step processes that often require mass manufacturing of multi-component parts, which will later be assembled into the finished articles. These multi-components parts, to function as designed, must have uniform, virtually identical (within acceptable variations), size and shape. The requisite uniformity among the parts that are required to be identical can be defined by the extent to which minute variations in corresponding shapes and sizes among such mass-produced identical parts can be tolerated. The concern for uniformity is particularly important when multi-component parts that are required to be identical are manufactured at multiple locations, which may have somewhat different manufacturing conditions, equipment, and suppliers of the requisite material.

For example, virtually all plastic materials, to be molded into required parts, after having been heated to be liquefied and then cooled and solidified during the manufacturing process, typically shrink during cooling (a phenomenon commonly known as “mold shrinkage”), thereby reducing at least some of the resulting parts' physical dimensions from the ideal or nominal dimensions—and thus potentially causing lack of uniformity among these plastic components. Also, metal parts may experience deformation caused by welding during assembly of the required parts, which may affect uniformity among those parts. At the same time, the exact positioning of the requisite parts is required to enable a reliably stable process of their assembly into a finished product.

Therefore, variations from the ideal or nominal shape and sizes of the parts being assembled into a finished implement need to be within acceptable ranges of tolerances. As used herein, the term “tolerance” refers to an acceptable (tolerable) amount of variation of a specified shape and/or measurable dimension from the ideal/nominal shape of a part of the implements being assembled. As no item or any of its parts can be produced having shapes and dimensions precisely to the exact nominal value, tolerances are typically assigned to parts for manufacturing purposes, as boundaries for acceptable build. Hence, there are degrees of acceptable variation/deviation from the exact nominal value, suitable for a particular machine, process, or part. Tolerances can be applied to any shape and dimension. A manufactured part having the shape and/or dimension that exceed the tolerance will be unlikely a usable part for the intended purpose.

The successive assembly steps require a correct positioning of the parts being assembled. To accomplish this, the manufacturer needs to ensure that the size and geometry of all elements, including the parts being manufactured/assembled, match one another with a high-degree precision, requiring strict tolerances. These strict tolerances are often hard to achieve, particularly in the context of mass production of the components that may take place at various locations and under different business and environmental conditions, as is previously mentioned. Such mass production requires multiple tools, including, e.g., mold tools and components, which are typically installed on different machines and which are intended for making identical parts. For example, for the production of a handle for a personal-care tool, such as, e.g., an electric brush, which is typically designed to house a plurality of components (including, e.g., a motor, a battery, electronics, and a drive unit including at least a portion of a drive shaft, as well as to have other structural and functional attributes), the reliable uniformity and precision among the different tools and equipment parts are of high importance for the goal of achieving, and remaining within, the requisite tolerances.

### SUMMARY OF THE DISCLOSURE

The present disclosure is directed to addressing the problem of comforting the required tight tolerances in multi-component personal-care implements. This is done by providing a coupling section and a handle for a multi-component personal-care implement, which coupling section includes a novel functional element—a tolerance-compensation element—that would allow manufacturers to appreciably relax otherwise strict tolerances for certain parts and manufacturing processes, while maintaining the requisite reliability and functionality of the parts being produced and assembled. The present disclosure, therefore, offers a novel coupling section and a handle for a mass-produced multi-component personal-care implements, as well as a more reliable and stable process of manufacturing and assembling parts required for such mass-produced multi-component personal-care implements.

In one aspect, the present disclosure is directed to a coupling section for a personal-care implement. The coupling section comprises a drive shaft that has a longitudinal axis and a free end. The personal-care implement may have any suitable operation frequency. In one example embodiment, the drive shaft can be configured to have an operation frequency of from about 50 Hz to about 270 Hz. The coupling section may include at least one first magnetic coupling element mounted adjacent at the free end of the drive shaft for connection, by magnetic interaction, with at least one second magnetic coupling element of a replaceable attachment tool. In the context of oral-care, such replaceable attachment tool may comprise a movable (e.g., vibrating, rotating, oscillating) brush head.

In one example embodiment, the coupling section has a cap having a longitudinal axis L2 and comprising a tubular structure. The cap has a first (open) end and a second end opposite to the first end. The cap may house the at least first magnetic coupling element that is disposed adjacent to the second end of the cap. The handle further may comprise a bushing having a first (open) end and a second end opposite to the first end. The bushing can be fixed inside the cap to be adjacent to the first end of the cap so that the first end of the bushing is adjacent to the first end of the cap.

A tolerance-compensation element can be arranged at the first end of the bushing. The tolerance-compensation element has a through-hole that is sized to receive the drive shaft therethrough. The drive shaft is inserted, through the tolerance-compensation element, into the bushing and is affixed to the drive shaft and to the bushing.

The bushing can be beneficially sized to loosely receive therein a portion of the drive shaft, so that there is a clearance (empty space) inside the bushing between the inner surface of the bushing and the outer surface of the portion of the drive shaft being inserted thereinto. Thus, the drive shaft can have some (limited) freedom of movement inside the bushing. That allows the drive shaft to move inside the bushing and to be adjusted therein.

The drive shaft can be adjusted, e.g., by being moved along its longitudinal axis, up and/or down, resulting in longitudinal tolerance compensation; by being moved laterally so that there is a distance formed between the longitudinal axis of the drive shaft and the longitudinal axis of the cap (and/or bushing), resulting in lateral tolerance compensation; and by causing the shaft to tilt (to be angled) relative to the longitudinal axis of the cap so that the longitudinal axis of the drive shaft is not parallel to the longitudinal axis of the cap, resulting in angular tolerance compensation. Of course, any combination of longitudinal tolerance compensation, lateral tolerance compensation, and angular tolerance compensation can have place, as needed. Such adjustment(s), if needed, can effectively remedy a potential or real misalignment exceeding the otherwise requisite tolerances among the parts being assembled, thereby effectively relaxing such strict tolerances. This would simplify and streamline the process of assembling the product, making the process more flexible and the product less expensive.

After the drive shaft has been adjusted inside the bushing to compensate for variation of a shapes and/or dimensions of a part being assembled, the tolerance-compensation element can be affixed to the drive shaft and to the bushing, e.g., by at least one of gluing and welding, e.g., laser-welding.

In one embodiment, the tolerance-compensation element comprises a disk-like structure having an outer diameter of from about 3 mm to about 12 mm and a through-hole having a diameter of from about 1 mm to about 6 mm. The tolerance-compensation element may have a thickness of from about 0.2 mm to about 2 mm.

The at least one first magnetic coupling element may comprise at least one permanent magnet and/or at least one magnetizable element. The handle may beneficially include a magnet seal disposed in the cap between the first magnetic coupling element and the bushing.

In another aspect, the present disclosure is directed to a handle for a personal-care implement comprising the coupling section as is described herein.

In still another aspect, the present disclosure is directed to a process of making a handle for a personal-care implement, wherein the handle comprises a drive unit including a drive shaft.

The process comprises the steps of: providing a cap comprising a tubular structure and having a first end and a second end opposite to the first end, the second end of the cap being an open end; inserting at least one first magnetic coupling element into the cap so that the at least one first magnetic coupling element is disposed adjacent to the second end of the cap; providing a bushing having a first end and a second end opposite to the first end, the second end of the bushing being an open end; mounting a bushing inside the cap and adjacent to the second end of the cap so that the second end of the bushing is adjacent to the second end of the cap; providing a tolerance-compensation element having a through-hole sized to receive the drive shaft therethrough; arranging a tolerance-compensation element at the second end of the bushing; inserting a portion of the drive shaft, through the through-hole of the tolerance-compensation element, into the bushing, wherein there is a clearance (empty space) between an inner surface of the bushing and an outer surface of a portion of the drive shaft inserted into the bushing so that the drive shaft has a freedom of movement inside the bushing; and affixing the tolerance-compensation element to the drive shaft and to the bushing.

The process may further include a steps of arranging a magnet seal in the cap and/or a step of pressing the tolerance-compensation element against the second end of the bushing. The step of fixing a bushing inside the cap may comprise mounting the bushing by press-fitting, crimping, shrink-fitting, gluing, welding, snapping, or any combination thereof. In one beneficial embodiment, the step of fixing a bushing in the cap further comprises laser-welding of the bushing to the tubular structure of the cap.

In one embodiment, the step of affixing the tolerance-compensation element to the drive shaft and to the bushing comprises laser-welding of the tolerance-compensation element to the second end of the bushing.

The process may further comprise a step of adjusting a position of the drive shaft inside the bushing prior to the step of affixing the tolerance-compensation element to the drive shaft and to the bushing. The step of adjusting a position of the drive shaft inside the bushing may include moving the drive shaft along its longitudinal axis (up or down), inclining the drive shaft relative to the longitudinal extension of the cap so that the longitudinal axis of the drive shaft is not parallel to the longitudinal axis of the cap, moving the drive shaft in a lateral direction (i.e., substantially perpendicular to the longitudinal axis of the drive shaft) so that the longitudinal axis of the drive shaft and the longitudinal axis of the cap do not coincide with one another and there is a distance between the two, and any combination thereof.

In another aspect, the disclosure is directed to a coupling section for coupling a handle of a personal-care implement and a replaceable attachment tool, wherein the coupling section comprises a bushing having a longitudinal axis and a first end and a second end opposite to the first end, a drive shaft having a longitudinal axis and a free end terminating in the bushing, the free end of the drive shaft being inserted into the bushing through the first end thereof, a first magnetic coupling element mounted adjacent to the second end of the bushing, and an elastic magnet seal disposed between the first magnetic coupling element and the bushing, the magnet seal being structured and configured to flex in at least a direction along the longitudinal axis of the bushing, thereby providing at least longitudinal tolerance compensation for the drive shaft relative to the first magnetic coupling element.

### BRIEF DESCRIPTION OF THE DRAWINGS

While the specification concludes with claims that particularly point out and distinctly claim the subject matter that is regarded as the invention, the various embodiments will be better understood from the following description taken in conjunction with the accompanying drawings, in which:

FIG. 1 is a schematic front view of an embodiment of a personal-care implement comprising a handle and a replaceable/disposable brush head attached to the handle.

FIG. 2 is a schematic partial view of the embodiment of the handle and the head shown in FIG. 1, wherein the head is disconnected from the handle.

FIG. 3 is a schematic partial cross-sectional view of an embodiment of the personal-care implement having a coupling section and comprising a handle and a replaceable/disposable brush head attached to the handle.

FIG. 4 is a schematic view of a disassembled portion of a coupling section of the personal-care implement comprising a tolerance-compensation element.

FIG. 5 is a schematic cross-sectional view of an embodiment of a tolerance-compensation element.

FIG. 5A is a schematic top view of the tolerance-compensation element shown in FIG. 5.

FIG. 5B is a schematic top view of the tolerance-compensation element that partially encircles the drive shaft.

FIG. 6 is a schematic view of an assembled portion of a coupling section of the personal-care implement comprising a tolerance-compensation element.

FIG. 7 schematically represents a step in a process of making the personal-care implement and schematically shows a cross-sectional view of a cap.

FIG. 8 schematically represents a step in the process of making the personal-care implement and schematically shows a cross-sectional view of the cap and a magnet element inserted into the cap.

FIG. 9 schematically represents a step in the process of making the personal-care implement and schematically shows a cross-sectional view of the cap, the magnet element, and a magnet seal.

FIG. 10 schematically represents a step in the process of making the personal-care implement and schematically shows a cross-sectional view of the cap, the magnet element, the magnet seal, and a bushing.

FIG. 11 schematically represents a step in the process of making the personal-care implement and schematically shows a cross-sectional view of the cap, the magnet element, the magnet seal, the bushing, and a tolerance-compensation element.

FIG. 12 schematically represents a step in the process of making the personal-care implement and schematically shows a cross-sectional view of the cap, the magnet element, the magnet seal, the bushing, the tolerance-compensation element, and a drive shaft.

FIG. 12A schematically illustrates that a clearance between an inner surface of the bushing and an outer surface of a portion of the drive shaft inserted into the bushing allows the drive shaft a freedom of angular movement inside the bushing.

FIG. 12B schematically illustrates that a clearance between an inner surface of the bushing and an outer surface of a portion of the drive shaft inserted into the bushing allows the drive shaft a freedom of movement in a lateral direction inside the bushing.

FIG. 13 schematically represents a step in the process of making the personal-care implement, the step comprising laser-welding of the tolerance-compensation element to the busing and to the drive shaft.

FIG. 14 is a perspective view of a portion of the personal-care implement in making, schematically showing a down-holder tool that is adjacent to, but not in contact with, the tolerance-compensation element.

FIG. 15 is a perspective view of the portion of the personal-care implement shown in FIG. 14, and schematically showing the down-holder tool in contact with the tolerance-compensation element.

FIGS. 16A-16L schematically show a fragment of a coupling section having various example embodiments of the magnet seal.

FIG. 17A schematically illustrates relationship between dimensions of an example embodiment of a magnet seal and dimensions of the surrounding structures in an assembled coupling section, wherein the magnet seal is shown, for illustrative purposes, in its non-compressed condition.

FIG. 17B is similar to FIG. 17A and schematically illustrates another example embodiment of a magnet seal, in its non-compressed/unconstrained condition, in an assembled coupling section.

FIG. 18A schematically shows a side view of an example embodiment of a magnet seal.

FIG. 18B schematically shows a cross-sectional view of the embodiment of the magnet seal shown in FIG. 18A.

FIG. 19 schematically shows a fragment of a personal-care implement having a coupling section wherein a magnet seal functions as a tolerance-compensation element.

### DETAILED DESCRIPTION

The following description does not attempt to list every possible embodiment of the invention because that would be impractical if not impossible. This disclosure, therefore, is to be construed as containing representative examples or embodiments of the invention. That is, any feature, characteristic, structure, component, element, or step described herein can be combined with or substituted for, in whole or in part, any other suitable feature, characteristic, structure, component, element, or step described herein. It should also be understood that the relative scale of some elements shown in the drawings may not be exact, as the dimensions, including thickness/height, of the components exemplified in the several example embodiments may be exaggerated for the purposes of illustration.

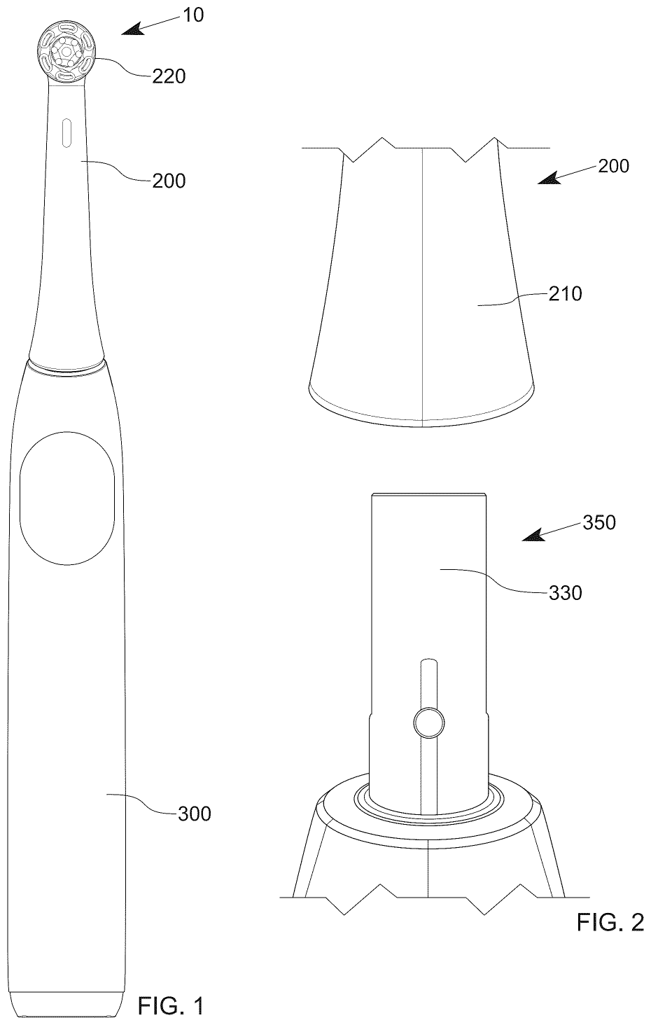

An example embodiment of a personal-care implement 10 shown in FIGS. 1-3 is an electric toothbrush that comprises a handle 300 and a replaceable attachment tool 200. The attachment tool 200 shown in this example embodiment is a brush head. As is known in the art, the replaceable attachment tool 200 comprises a housing having a head section including a head cavity for accommodating a movable oral-cleaning head 220 and a neck section 210 having a neck cavity therein inside, and a coupling section 350, for coupling the replaceable attachment tool 200 to the handle 300.

As is disclosed in commonly assigned U.S. Pat. Nos. 8,631,532, 9,226,808, and 9,387,059, the entire disclosures of which are incorporated herein by reference, a magnetic force between a first magnetic coupling element and a second magnetic coupling element (at least one of which could be a permanent magnet or a magnetizable element) can be used to form mechanical handle drive shaft connection to a replaceable attachment tool. One of the magnetic coupling elements may be arranged at the handle's drive shaft, and another inside the attachment tool.

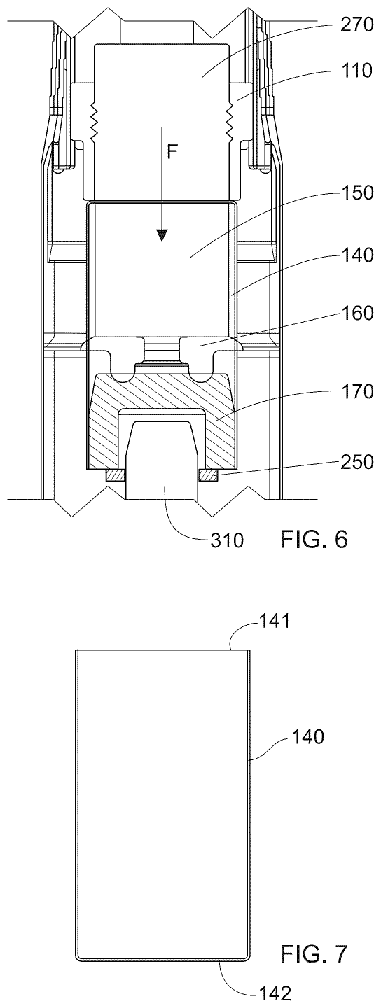

As is shown in FIGS. 1-3, the handle 300 of the personal-care implement 10 comprises a drive unit 330 including a drive shaft 310 that has a longitudinal axis L1 and a free end 311. A coupling section 350 includes components for coupling the replaceable attachment tool 200 (e.g., a brush head) to the handle 300, as is known in the art. In the instance of an electric toothbrush (exemplified in FIG. 1), the drive shaft 310 can have an operation frequency of from about 50 Hz to about 270 Hz. The coupling section 350 includes a first magnetic coupling element 150 mounted at the free end 311 of the drive shaft 310 for connection, by magnetic interaction, with the second magnetic coupling element 270 (e.g., a metal cylinder) mounted at a motion transmitter that extends inside the neck cavity of the neck 210 to the head cavity of a replaceable attachment tool 200 that is arranged for a brushing movement, e.g., rotational oscillation. Magnetic force F existing between the first magnetic coupling element 150 and the second magnetic coupling element 270 is schematically shown in FIG. 6.

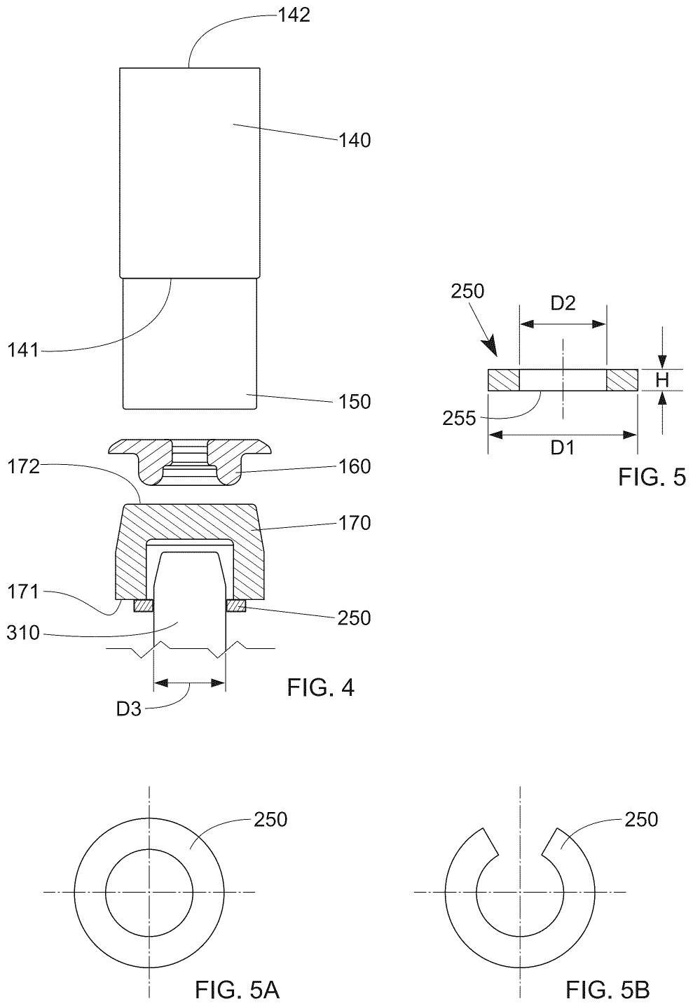

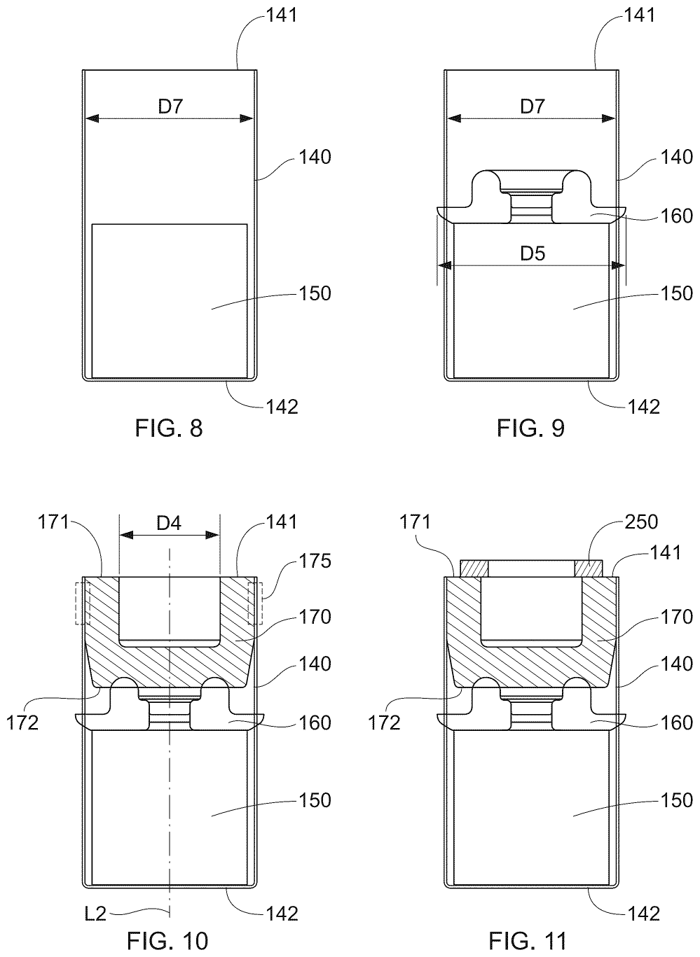

The coupling section 350 may include a cap 140 having a longitudinal axis L2 and comprising an essentially tubular structure. The cap 140 has a first (open) end 141 and a second end 142 opposite to the first end 141 (FIGS. 4 and 7). The cap 140 had an inner diameter D7 (FIGS. 8, 16A, 17A, 17B). The cap 140 houses inside the first magnetic coupling element 150 that is disposed adjacent to the second end 142 of the cap 140.

The coupling section 350 may further include a bushing 170 having a first (open) end 171 and a second end 172 opposite to the first end 171. The bushing 170 can be fixed inside the cap 140, e.g., by press-fitting and/or laser welding, to be disposed adjacent to the first end 141 of the cap 140 so that the first end 171 of the bushing 170 is neighboring the first end 141 of the cap 140 (FIGS. 10, 11). As the bushing 170 is securely fixed inside the cap 140 so that a longitudinal extension of the bushing is substantially parallel to a longitudinal extension of the cap 140, both the cap 140 and the bushing 170 share the longitudinal axis L2 (FIG. 10). The longitudinal axis L2, therefore, can be referred to as “the longitudinal axis L2 of the bushing 170” and/or “the longitudinal axis L2 of the cap 140” or “the longitudinal axis L2 of (both) the bushing 170 and the cap 140.”

As is best shown in FIGS. 4 and 11, a tolerance-compensation element 250 can be arranged at the first end 171 of the bushing 170. An embodiment of the tolerance-compensation element 250 illustrated herein has a through-hole 255 having a diameter D2 (FIG. 5), sized to receive the drive shaft 310 therethrough. The drive shaft 310 is inserted, through the tolerance-compensation element 250, into the bushing 170 and is affixed to the tolerance compensation element 250 and to the bushing 170.

The bushing 170 is sized to loosely receive the free end of the drive shaft 310 being inserted into the bushing 170. The term “loosely” in the present context indicates that the outer diameter D3 of the portion of the drive shaft 310 that is inserted into the bushing 170 is somewhat smaller than an inner diameter D4 of the bushing 170, so that there is a clearance, or empty space, between an inner surface of the bushing 170 and an outer surface of the portion of the drive shaft 310 inserted into the bushing 170, which empty space allows the shaft 310 to move inside and relative to the bushing 170. In other words, there is no “tight” fitting between the bushing 170 and the portion of the drive shaft 310 inserted into the bushing 170. This clearance, or empty space, existing between the inner surface of the bushing 170 and the outer surface of the portion of the drive shaft 310 inserted into the bushing 170 allows the drive shaft 310 to have a freedom of movement inside the bushing 170 during assembly.

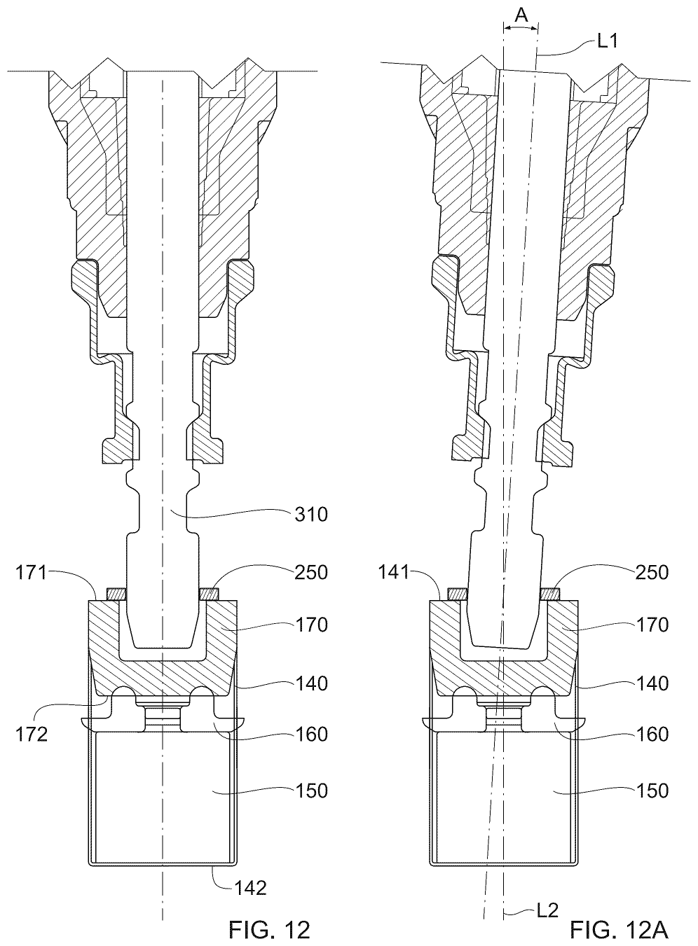

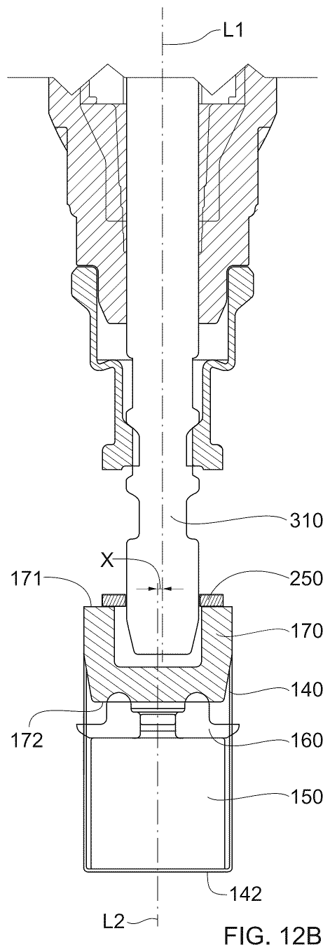

This freedom of movement of the drive shaft 310 inside the bushing 170 may include a freedom of movement in an axial direction (i.e., along the longitudinal axis L1 of the drive shaft 310), resulting in a longitudinal tolerance compensation; a freedom of movement in a lateral direction so that a distance “X” is formed between the longitudinal axis L1 of the drive shaft 310 and the longitudinal axis L2 of the cap 140 (FIG. 12B), resulting in a lateral tolerance compensation; and a freedom of angular, or tilting, movement, causing the shaft 310 being slightly tilted, or inclined, relative to the longitudinal axis L2 of the cap 140 so that the longitudinal axis L1 of the drive shaft 310 is not parallel to the longitudinal axis L2 of the cap 140 (FIG. 12A), resulting in an angular tolerance compensation; and any combination of the above.

The freedom of movement of the drive shaft 310 inside the bushing 170 offers a manufacturer the ability to adjust, during assembly, the drive shaft 310 inside the bushing 170, thereby compensating for minor variation in size and dimensions of the parts being assembled, which variation may exceed the otherwise requisite tolerances among those parts and/or the surrounding structures. Such adjustment during assembly may include, e.g., slightly inclining the drive shaft 310 relative to the longitudinal extensions of the cap 140 and/or the bushing 170—which would result in a lack of perfect alignment between the longitudinal axis L1 of the drive shaft 310 and the longitudinal axis L2 of the cap 140. In other words, in some embodiments, the drive shaft 310 may be inclined relative to the longitudinal extension of the cap 140 so that the longitudinal axis L1 of the drive shaft 310 is not parallel to the longitudinal axis L2 of the cap 140, and there is an angle “A” formed between the longitudinal axis L1 and the longitudinal axis L2, as is schematically shown in FIG. 12A. Stated differently, the drive shaft 310 may have a position characterized by a degree of an angular deviation from an axial alignment with the longitudinal extensions of the cap 140. The angle “A” can be from 0 degree to about 25 degree, and more specifically from 0 degree to about 15 degree, and even more specifically from 0 degree to about 5 degree. In one embodiment, the angle “A” can be from about 0.2 degree to about 6 degree.

Such adjustment during assembly may also, alternatively or additionally, include moving the drive shaft 310 in the lateral direction relative to the longitudinal extensions of the cap 140 and/or the bushing 170, so that a distance “X” is formed between the longitudinal axis L1 of the drive shaft 310 and the longitudinal axis L2 of the cap 140 and/or the bushing 170 (FIG. 12B). That would result in the drive shaft 310 having a position characterized by a lateral deviation from an axial alignment with the longitudinal extensions of the cap 140. The distance “X” can be from about 0.005 mm to about 1 mm, and more specifically from about 0.01 mm to about 0.5 mm. In one embodiment, the tolerance compensation in the lateral direction may result in a distance “X” from about 0.005 mm to about 0.15 mm formed between the longitudinal axis L1 of the drive shaft 310 and the longitudinal axis L2 of the bushing 170.

Likewise, the drive shaft 310 can be moved/adjusted along its longitudinal axis L2, up and/or down the axis L2, resulting in a longitudinal tolerance compensation, as may be required during assembly. Of course, any of the tolerance-compensation adjustments described herein can be combined as needed. Thus, the drive shaft 310 may have a position characterized, e.g., by both a lateral deviation (lateral tolerance compensation) and an angular deviation (angular tolerance compensation) from the axial alignment with the longitudinal axis of the cap 140. Such adjustment(s), when desirable, can be effectively implemented to compensate for a misalignment among the parts being assembled, which misalignment could be caused by variations in the parts' shapes and sizes exceeding the requisite tolerances, e.g., for the reasons previously mentioned.

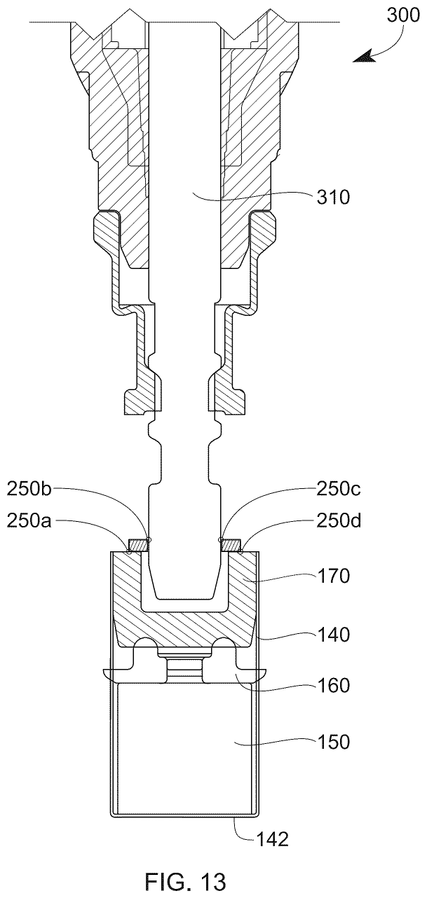

The tolerance-compensation element 250 can be affixed to the drive shaft 310 and to the bushing 170 by any means known in the art, e.g., by gluing and/or welding. In one beneficial embodiment, the tolerance-compensation element 250 is affixed to the drive shaft 310 and to the bushing 170 by laser-welding, e.g., at points 250a, 250b, 250c, and 250d, as is schematically illustrated in FIG. 13. The number of fixation points (four in FIG. 13) is for illustration purposes only—and any other suitable number of laser-welding points could be employed, if advisable, to fix the tolerance-compensation element 250.

In the example embodiments illustrated in FIGS. 5, 5A, and FIG. 5B, the tolerance-compensation element 250 comprises substantially a disk structure, or annulus—full (FIG. 5A) or partial (FIG. 5B). Other suitable shapes of the tolerance-elimination element 250, e.g., rectangular, polygonal, oval, and the like (not illustrated herein), are contemplated by the present disclosure. The tolerance-compensation element 250 may have an outer diameter (or the largest dimension measured through the geometric center of a non-round tolerance compensation element 250) D1 of from about 3 mm to about 12 mm. A through-hole of the tolerance-compensation element 250 may have a diameter D2 of from about 1 mm to about 6 mm. The through-hole may be centrally located, as is shown in FIGS. 5, 5A and 5B. The tolerance-compensation element 250 may have a thickness of from about 0.2 mm to about 2 mm.

The inner diameter D4 of the bushing 170 can be from about 1.5 mm to about 10 mm. The outer diameter D3 of the drive shaft 310 can be from about 1 mm to about 6 mm. In a specific arrangement to be assembled, the outer diameter D3 of the drive shaft 310 may be slightly (0.5%-5%) smaller than the diameter D2 of the through-hole of the tolerance-compensation element 250. That would allow the drive shaft 310 to have some limited freedom of angular movement relative to the tolerance-compensation element 250 during assembly of the implement. In other words, the drive shaft 310 could be slightly inclined relative to the tolerance compensation element 250 so that the longitudinal axis L1 of the shaft 310 is not strictly perpendicular to the lateral extension of the tolerance-compensation element 250.

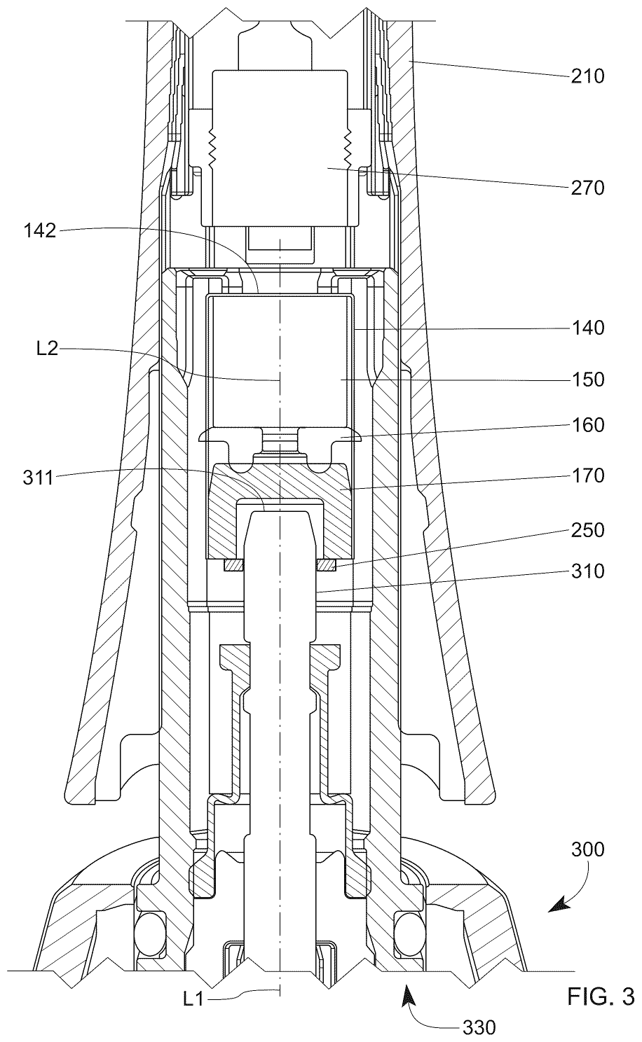

The first magnetic coupling element 150 may comprise at least one of a permanent magnet and a magnetizable element, for providing magnetic connection with the corresponding second magnetic coupling element 270 (such as, e.g., a metal cylinder) arranged in a replaceable attachment tool 200. As is shown in FIGS. 3, 4, 6, 9-13, and 16A-16L, the handle 300 may beneficially include an elastic magnet seal 160 disposed in the cap 140 between the first magnetic coupling element 150 and the bushing 170. The magnet seal may protect the first magnetic coupling element 150 from moisture. It may also help to have the first magnetic coupling element 150 adequately pressed against the inner side of the cap surface. As the magnet seal 160 is elastic, it can additionally function as a shock-absorbing element that would protect the personal-care implement against stress in case of a drop.

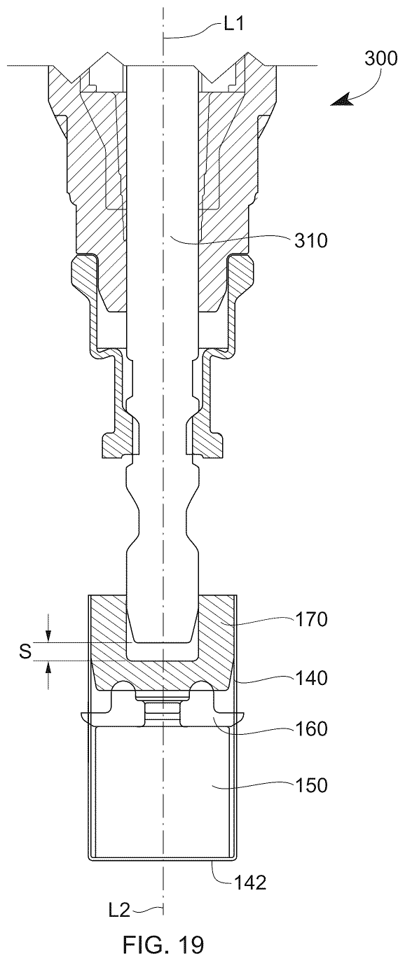

Furthermore, the magnet seal 160 may function as a flexible tolerance-compensation element, in combination with, or independently from, the tolerance-compensation element 250, previously described. As such, the magnet seal 160 can be structured and configured to flex to provide tolerance compensation for the drive shaft 310 in at least a longitudinal direction substantially parallel to the longitudinal axis L2 of the bushing 170. FIG. 19 illustrates an embodiment of the coupling section wherein the magnet seal 160 (shown in its non-compressed condition) functions as a tolerance-compensation element. As a result of tolerance compensation in the longitudinal direction, a distance S can be formed of formed between a free end of the drive shaft 310 and an inner surface of the bushing 170 facing the free end of the drive shaft 310. The distance S can be from about 0.001 mm to about 4 mm, and more specifically from about 0.01 mm to about 3 mm.

The magnet seal 160 can also be structured and configured to flex to provide tolerance compensation for the drive shaft 310 in a lateral direction substantially perpendicular to the longitudinal axis L2 of the bushing 170, and/or an angular direction resulting in an angle being formed between the longitudinal axis L2 of the bushing 170 and the longitudinal axis L1 of the drive shaft 310, as is previously described herein.

The magnet seal 160 may generally comprise a three-dimensional annular structure having any suitable shape. The seal 160 may be configured to flex in at least a direction along the longitudinal axis of the bushing 170 thereby providing at least longitudinal tolerance compensation for the drive shaft 310 relative to the first magnetic coupling element 150. As is described above, the magnetic seal 160 may also be structured to provide a lateral tolerance compensation and/or an angular tolerance compensation.

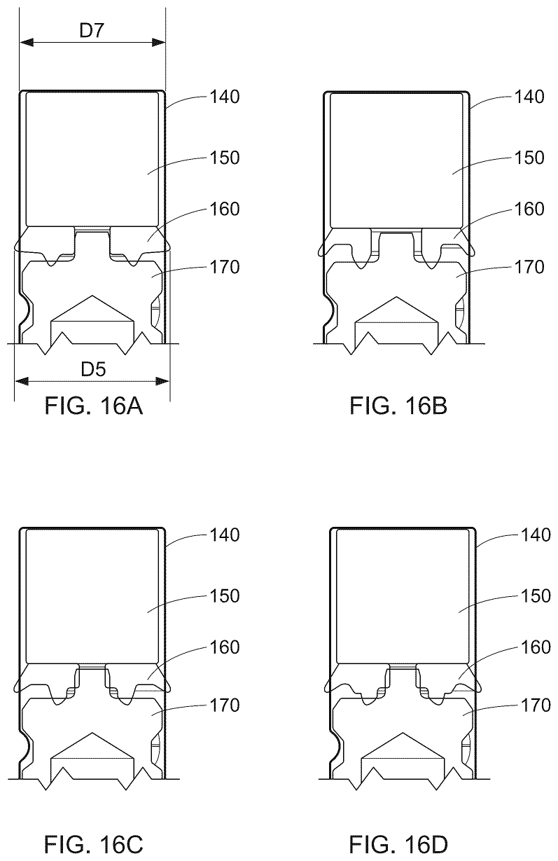

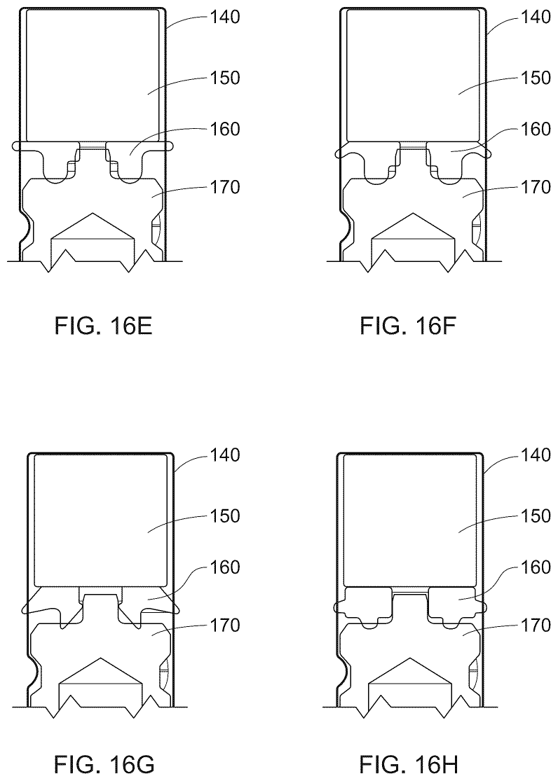

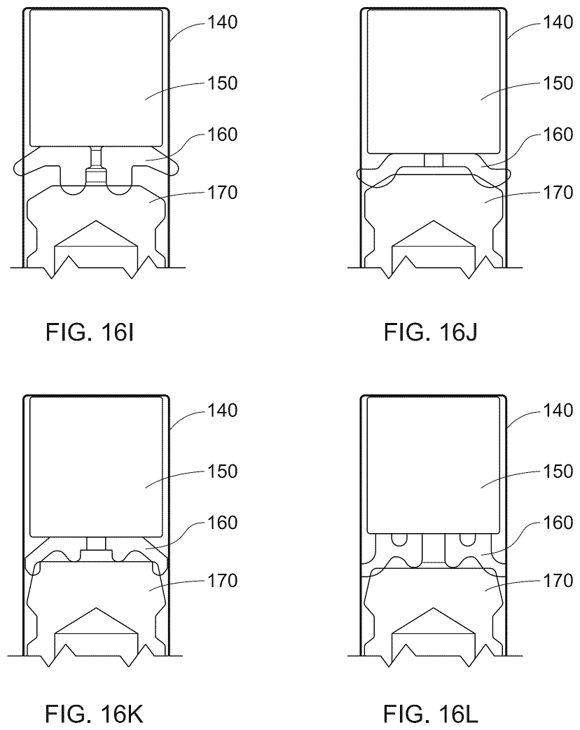

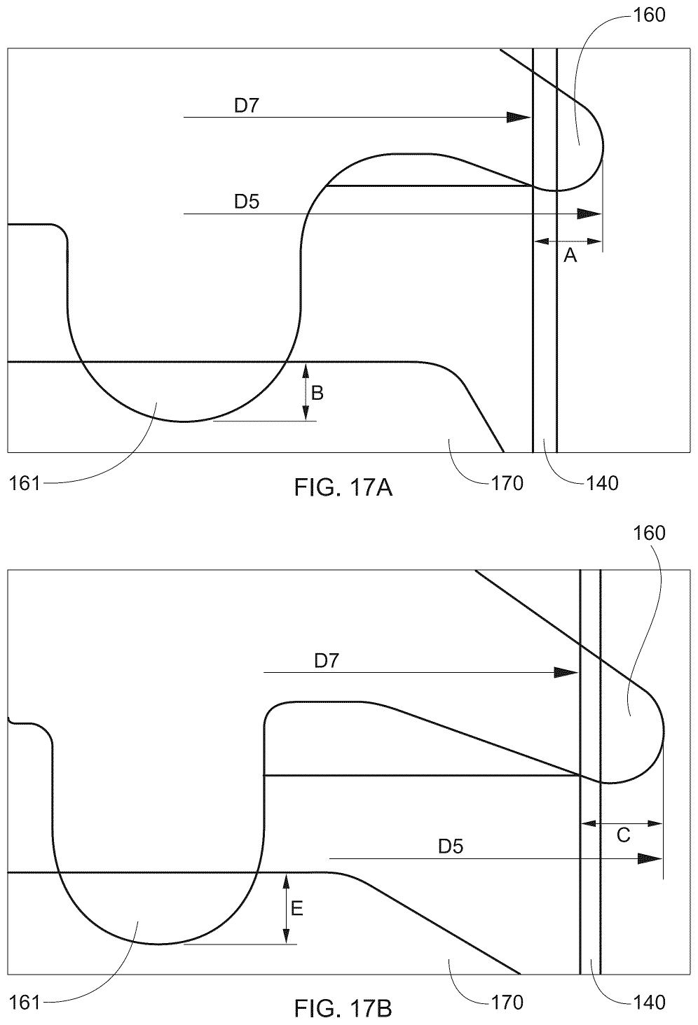

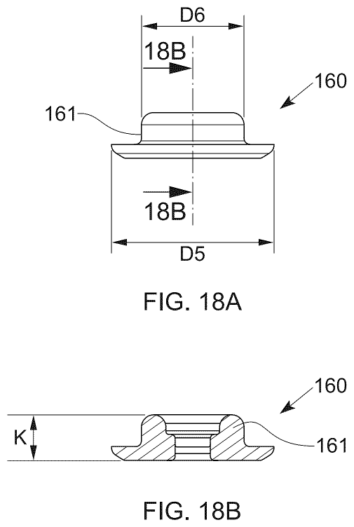

Various non-limiting example embodiments of the magnet seal 160 are illustrated in FIGS. 3, 4, 6, 9-13, 16A-16L, 17A, 17B, 18A, and 18B. The magnet seal 160 has an unconstrained outer diameter D5 that is greater than the inner diameter D7 of the cap 140 by at least 5 percent. The term “unconstrained” is used herein to define a given parameter/dimension (e.g., an outer diameter D5 (FIGS. 17A, 17B, and 18A) or an overall height K (FIG. 18B)) of the seal 160 in non-compressed condition, prior to the seal 160 being inserted into the cap 140 and/or compressed by the surrounding elements. The seal 160 is designed to be compressed (or squeezed) inside the cap 140 by the walls of the cap 140 (FIGS. 16K and 16L), thereby providing requisite insulation. A compressed, or constrained, overall diameter of the seal 160 is therefore smaller than the unconstrained diameter D5. The seal 160 is also compressed between the magnet coupling element 150 and the bushing 170, resulting in a compressed, or constrained, height that is smaller than the unconstrained height K of the seal 160.

The magnet seal 160 can have an unconstrained outer diameter D5 of from about 3 mm to about 13 mm, and more specifically from about 5 mm to about 10 mm. A ratio of the unconstrained outer diameter D5 of the magnet seal 160 to the inner diameter D7 of the cap 140 (the constrained outer diameter of the seal 140) can be from about 1.05 to about 1.25, and more specifically from about 1.1 to about 1.2. The magnet seal 160 can have an overall unconstrained height K (FIG. 18B) of from about 1 mm to about 4 mm, and more specifically from about 1.5 mm to about 3 mm. A ratio of the unconstrained height K to the constrained thickness of the magnet seal 140 can be from about 1.05 to about 1.4, and more specifically from 1.1 to about 1.3. A ratio of the unconstrained outer diameter D5 to the overall unconstrained height K of the magnet seal 160 can be from about 2 to about 5.

As is illustrated in the drawings herein, the magnet seal 160 may have at least one centrally located annular protrusion 161 outwardly extending from at least one side thereof and having an unconstrained outer diameter D6 (FIG. 18A). The at least one annular protrusion 161 extends generally parallel to the longitudinal axis of the cap 140. The unconstrained outer diameter D6 can be from about 2 mm to about 12 mm, and more specifically from about 4 mm to about 10 mm. At least a portion of a surface of the magnet seal 160 can be treated with non-stick coating comprising, e.g., fluorination, providing/facilitating a coefficient of friction below 0.2.

The magnet seal 160 can be made of a rubber material having a Shore A Hardness of from 40 to 60. Non-limiting examples of the rubber material include silicone or NBR or EPDM.

FIGS. 17A and 17B schematically illustrate relationship between the dimensions of the magnet seal 160 and the dimensions of the surrounding structures in the assembled coupling section 350, in which figures the magnet seal 160 is shown, for illustrative purposes, in its non-compressed condition. FIG. 17A illustrates an example embodiment of the magnet seal 140, wherein the unconstrained outer diameter D5 of the magnet seal 160 is greater than the inner diameter D7 of the cap 140 (by a double overlap “A”) and the unconstrained height of the magnet seal 160 is greater than the longitudinal dimension of the space inside the cap 140 (by a longitudinal overlap “B”) intended for containing the seal 160 when the coupling section 350 is fully assembled. FIG. 17B illustrates another example embodiment of the magnet seal 140, wherein the unconstrained outer diameter D5 of the magnet seal 160 is greater than the inner diameter D7 of the cap 140 (by a double overlap “C”) and the unconstrained height of the magnet seal 160 is greater than the longitudinal dimension of the space inside the cap 140 (by a longitudinal overlap “E”) intended for containing the seal 160 when the coupling section 350 is fully assembled.

In another aspect, the disclosure is directed to a coupling section 350 for coupling a handle 300 of a personal-care implement 10 and a replaceable attachment tool 200. The coupling section 350 comprises a drive shaft 310 having a longitudinal axis L1 and a free end 311 terminating in a bushing 170 having a first end 171 and a second end 172 opposite to the first end 171. The free end 311 of the drive shaft 310 is inserted into the bushing 170 through the first end 171 of the bushing 170. A first magnetic coupling element 160 is mounted adjacent to the second end 172 of the bushing.

A tolerance-compensation element 250 has a through-hole 255 sized to loosely receive the drive shaft 310 therethrough. The tolerance-compensation element 250 is mounted adjacent to the first end 171 of the bushing, and the free end 311 of the drive shaft 310 is disposed in the bushing 170 so that there is a space between an inner surface of the bushing 170 and an outer surface of the drive shaft 310. The tolerance-compensation element 250 is affixed to the drive shaft 310 and to the bushing 170—and at least partially encircles a portion of the drive shaft 310 adjacent to the first end 171 of the bushing 170. An embodiment of the tolerance-compensation element 250, having a shape of a partial annulus (somewhat resembling a general outline of a horseshoe), as is illustrated in FIG. 5B, would partially encircle a portion of the drive shaft 310 adjacent to the first end 171 of the bushing 170.

A process of making a handle 300 for a personal-care implement 10 comprises the steps of providing a cap 140 comprising a tubular structure and having a first end 141 and a second end 142 opposite to the first end 141, the first end of the cap being an open end (FIG. 7); inserting a first magnetic coupling element 150 into the cap 140 so that the first magnetic coupling element 150 is disposed adjacent to the second end 142 of the cap 140 (FIG. 8); providing a bushing 170 having a first end 171 and a second end 172 opposite to the first end 171, the first end 171 of the bushing 170 being an open end and mounting a bushing 170 inside the cap 140 and adjacent to the first end 141 of the cap so that the first end of the bushing 171 is adjacent to the first end 141 of the cap 140 (FIG. 10); providing a tolerance-compensation element 250 having a through-hole 255 sized to receive the drive shaft 310 therethrough and arranging the tolerance-compensation element 250 at the first end 171 of the bushing 170 (FIG. 11); inserting a portion of the drive shaft 310, through the through-hole 255 of the tolerance-compensation element 250, into the bushing 170, wherein there is a clearance between an inner surface of the bushing 170 and an outer surface of the portion of the drive shaft 310 inserted into the bushing 170 so that the drive shaft 310 has a freedom of movement inside the bushing 170 (as previously described, FIGS. 12, 12A, and 12B); and affixing the tolerance-compensation element 250 to the drive shaft 310 and to the bushing 170 (FIG. 13).

In one embodiment, the process includes a step of arranging a magnet seal 160 in the cap 140 (FIG. 9). The magnet seal 160 may be needed to protect the magnetic coupling element 150 from moisture and to press the magnetic coupling element 150 against the inner side of the cap surface. As the seal 160 is elastic, it can also act as a shock-absorbing element and protection against stress if the implement is dropped or otherwise shaken or hits a hard surface.

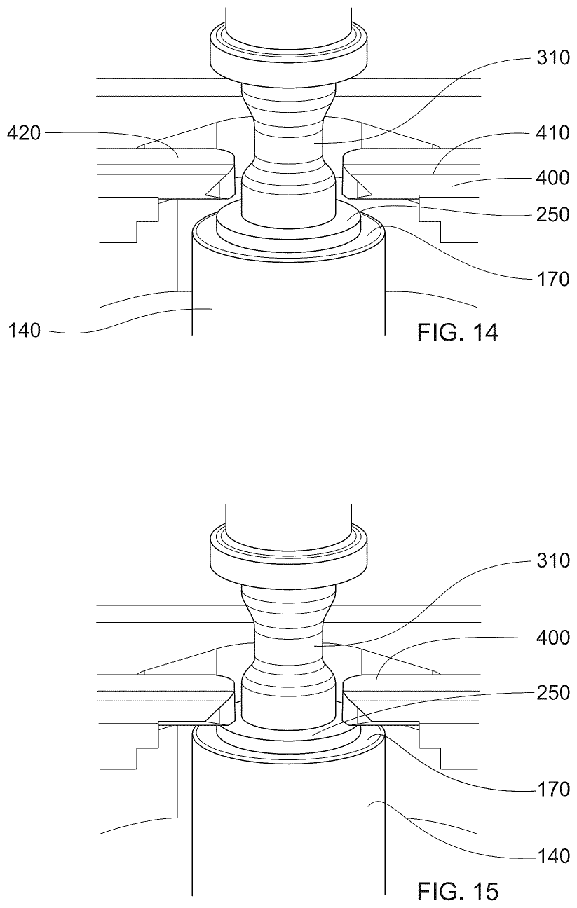

In one embodiment, the process includes a step of pressing the tolerance-compensation element 250 against the first end 171 of the bushing 170 (FIGS. 14, 15) to facilitate fixation of the tolerance-compensation element to the bushing 170. As is shown in FIGS. 14 and 15, a down-holder tool, or clamp, 400 may be used to press and hold the tolerance-compensation element 250 against the first end 171 of the bushing 170. The down-holder tool 400 may comprise, e.g., two mutually opposing (or more than two) prongs 410, 420 structured and configured to contact the top of the tolerance-compensation element 250 and apply a requisite pressure to hold the tolerance-compensation element 260 in place against the bushing 170 for affixing the tolerance-compensation element 250 to the first end 171 of the busing 170 and the drive shaft 310. The down-holder tool 400 can be driven pneumatically, electrically, mechanically, hydraulically, or by any other means known in the art and suitable for this purpose.

The step of fixing the bushing 170 inside the cap 140 may comprise mounting the bushing 170 by press-fitting, crimping, shrink-fitting, gluing, welding, snapping, or any combination thereof. In one beneficial embodiment, schematically illustrated in FIG. 10, the step of fixing the bushing 170 in the cap 140 may further comprise laser-welding of the bushing 170 to the tubular structure of the cap 140, e.g., at areas 175.

The process may further comprise a step of adjusting a position of the drive shaft 310 inside the bushing 170 prior to the step of affixing the tolerance-compensation element 250 to the drive shaft 310 and to the bushing 170. In one embodiment, the step of adjusting a position of the drive shaft 310 inside the bushing 170 comprises positioning the drive shaft 310 inside the bushing 170 so that the longitudinal axis L1 of the drive shaft 310 is not strictly parallel to the longitudinal axis L2 of the cap 140, as is illustrated in FIG. 12A.

In another aspect, the disclosure is directed to a coupling section for coupling a handle of a personal-care implement and a replaceable attachment tool, wherein the coupling section comprises a bushing having a longitudinal axis and a first end and a second end opposite to the first end, a drive shaft having a longitudinal axis and a free end terminating in the bushing, the free end of the drive shaft being inserted into the bushing through the first end thereof, a first magnetic coupling element mounted adjacent to the second end of the bushing, and an elastic magnet seal disposed between the first magnetic coupling element and the bushing, the magnet seal being structured and configured to flex in at least a direction along the longitudinal axis of the bushing, thereby providing at least longitudinal tolerance compensation for the drive shaft relative to the first magnetic coupling element.

The dimensions and values disclosed herein are not to be understood as being strictly limited to the exact numerical values recited. Instead, each such dimension is intended to mean both the recited value and a functionally equivalent range surrounding that value, unless otherwise specified. For example, a dimension disclosed as “10 mm” is intended to mean “about mm.”

The disclosure of every document cited herein, including that of any cross-referenced or related patent or application, is incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A coupling section for coupling a handle of a personal-care implement and a replaceable attachment tool, the coupling section comprising:
a cap comprising a generally tubular structure having an inner diameter D4, the cap having a first end and a second end opposite to the first end, the first end of the cap being an open end,
a bushing mounted inside the cap and having a longitudinal axis and a first end and a second end opposite to the first end, the first end of the bushing being an open end, the bushing being adjacent to the first end of the cap so that the first end of the bushing is adjacent to the first end of the cap;
a drive shaft having a longitudinal axis and a free end terminating in the bushing, the free end of the drive shaft being inserted into the bushing through the first end thereof;
a first magnetic coupling element mounted adjacent to the second end of the bushing; and
an elastic magnet seal disposed between the first magnetic coupling element and the bushing, the magnet seal having a first side and a second side opposite to the first side, the magnet seal being structured and configured to flex in at least a direction along the longitudinal axis of the bushing, thereby providing at least longitudinal tolerance compensation for the drive shaft relative to the first magnetic coupling element.

2. The coupling section of claim 1, wherein the first magnetic coupling element is disposed in the cap and adjacent to the second end of the cap and wherein the magnet seal is disposed inside the cap between the first magnetic coupling element and the bushing.

3. The coupling section of claim 1, wherein the magnet seal comprises a generally annular structure having an unconstrained outer diameter D5 that is greater than the inner diameter D7 of the cap by at least 5 percent.

4. The coupling section of claim 1, wherein the unconstrained outer diameter D5 is from about 3 mm to about 13 mm.

5. The coupling section of claim 3, wherein a ratio of the unconstrained outer diameter D5 of the magnet seal to the inner diameter D7 of the cap is from about 1.05 to about 1.25.

6. The coupling section of claim 3, wherein the magnet seal has an overall unconstrained height K of from about 1 mm to about 4 mm.

7. The coupling section of claim 3, wherein a ratio of the unconstrained outer diameter D5 to the overall unconstrained height K of the magnet seal is from about 2 to about 5.

8. The coupling section of claim 3, wherein the magnet seal comprises a centrally located annular protrusion outwardly extending from at least one side thereof.

9. The coupling section of claim 8, wherein the annular protrusion has an unconstrained outer diameter D6 of from about 2 mm to about 12 mm.

10. The coupling section of claim 3, wherein the magnet seal is made of rubber having a Shore A Hardness of from 40 to 60.

11. The coupling section of claim 10, wherein at least a portion of a surface of the magnet seal is treated with non-stick coating comprising fluorination treatment.

12. The coupling section of claim 1, wherein the magnet seal is structured and configured to flex, thereby providing tolerance compensation selected from lateral tolerance compensation and angular tolerance compensation for the drive shaft relative to the longitudinal axis of the bushing.

13. The coupling section of claim 12, wherein the lateral tolerance compensation results in a distance being formed between the longitudinal axis of the bushing and the longitudinal axis of the drive shaft.

14. The coupling section of claim 12, wherein the angular tolerance compensation results in an angle being formed between the longitudinal axis of the bushing and the longitudinal axis of the drive shaft.

15. The coupling section of claim 13, wherein the distance formed between the longitudinal axis of the bushing and the longitudinal axis of the drive shaft is from about 0.005 mm to about 1 mm.

16. The coupling section of claim 14, wherein the angle formed between the longitudinal axis of the bushing and the longitudinal axis of the drive shaft is from about 0.2 degree to about 6 degree.

17. The coupling section of claim 1, wherein the at least longitudinal tolerance compensation for the drive shaft relative to the first magnetic coupling element results in a distance of from about 0.001 mm to about 4 mm formed between a free end of the drive shaft and an inner surface of the bushing facing the free end of the drive shaft.

18. A handle of a personal-care implement having a coupling section for attaching the handle to a replaceable attachment tool, the coupling section comprising:
a bushing having a longitudinal axis and a first end and a second end opposite to the first end;
a drive shaft having a longitudinal axis and a free end terminating in the bushing, the free end of the drive shaft being inserted into the bushing through the first end thereof;
a first magnetic coupling element mounted adjacent to the second end of the bushing; and
an elastic magnet seal disposed between the first magnetic coupling element and the bushing, the magnet seal being structured and configured to flex, thereby providing tolerance compensation for the drive shaft in at least one direction selected from a longitudinal direction substantially parallel to the longitudinal axis of the bushing, a lateral direction substantially perpendicular to the longitudinal axis of the bushing, and an angular direction resulting in an angle being formed between the longitudinal axis of the bushing and the longitudinal axis of the drive shaft.

19. The handle of claim 18, wherein the tolerance compensation in the lateral direction results in a distance from about 0.005 mm to about 0.15 mm formed between the longitudinal axis of the drive shaft and the longitudinal axis of the bushing.

20. The handle of claim 18, wherein the angle formed between the longitudinal axis of the bushing and the longitudinal axis of the drive shaft is from about 0.2 degree to about 6 degree.
